(19) United States
(12) Patent Application Publication
(10) Pub. No.: US 2025/0115322 A1
(43) Pub. Date: Apr. 10, 2025

(54) SEAT SUPPORT DEVICE AND BICYCLE

(71) Applicant: Yamaha Hatsudoki Kabushiki Kaisha, Shizuoka (JP)

(72) Inventors: Tomoki TANAKA, Shizuoka (JP); Masahiro KUROKI, Shizuoka (JP); Masahiro YOSHIDA, Shizuoka (JP)

(21) Appl. No.: 18/907,431

(22) Filed: Oct. 4, 2024

(30) Foreign Application Priority Data
Oct. 6, 2023 (JP) 2023-174584

(51) Int. Cl. B62J 1/08; B62J 1/02

(52) U.S. Cl. CPC B62J 1/08; B62J 1/02; B62J 2001/085

(57) ABSTRACT

A seat support device includes a seat post including a lower post supported so as to be movable forward and rearward centering on a support shaft and an upper post movable upward and downward relative to the lower post. The seat position adjustment mechanism switches between a locked state in which a relative position between the upper post and the lower post is locked, and an unlocked state. The seat support device includes a coupling arm coupled to the upper post. A foremost part of the coupling arm is supported by a support shaft so that the coupling arm and the upper post are movable upward and downward centering on the support shaft.

### CROSS-REFERENCE TO RELATED APPLICATION

The present application claims priority from Japanese application JP2023-174584 filed on Oct. 6, 2023, the content of which is hereby incorporated by reference into this application.

### BACKGROUND OF THE INVENTION

### 1. Field of the Invention

The present disclosure relates to a support structure of a seat in a bicycle.

### 2. Description of the Related Art

The bicycle disclosed in JP 2003-104257 A includes a seat position adjustment mechanism having a gas spring in a seat post. The seat position adjustment mechanism includes an operating lever disposed at a lower side of the seat. When operating this operating lever, a piston and the seat are pushed up by gas pressure. When releasing the operation of the operating lever, positions (height) of the piston and the seat are locked. A bicycle in which the operating lever for adjusting the position of the seat is attached to a handle lever unlike JP 2003-104257 A is also used.

In the seat position adjustment mechanism in the related art, the seat position only changes in a vertical direction (a drawing direction of a cylinder). However, there is a need for changing the seat position in a front-back direction. For example, when riding up a hill, it is easier for a rider to pedal when the seat is located at a position high and closer to a front portion of a vehicle. In contrast, when riding down a hill, it is easier to operate the bicycle in some cases when the seat is at a position low and closer to a rear portion of the vehicle.

### SUMMARY OF THE INVENTION

(1) An example of a seat support device proposed in the present disclosure includes a seat post which includes a lower post supported so as to move forward and rearward centering on a first support shaft, and an upper post extending upward from the lower post, the upper post being configured to support a seat located at an upper side of the upper post and movable upward and downward relative to the lower post, a seat position adjustment mechanism configured to switch between a locked state in which a relative position between the upper post and the lower post is locked, and an unlocked state in which a change in the relative position between the upper post and the lower post is allowed, and a coupling arm coupled to the upper post. A foremost part of the coupling arm is supported by a second support shaft located in front of the seat post so that the coupling arm and the upper post are movable upward and downward centering on the second support shaft.

According to this seat support structure, it is possible to change a position of a seat not only in a vertical direction, but also in a front-back direction.
(2) In the seat support device described in (1), the seat position adjustment mechanism includes a biasing unit configured to bias the upper post upward with respect to the lower post in the unlocked state, and is configured to switch between the locked state and the unlocked state in accordance with an operation on an operating unit by a user. This makes it possible for the rider to easily perform the adjustment of the seat position.
(3) In the seat support device described in (1) or (2), the seat post is configured to move between a high post state in which the upper post is disposed at a relatively high position, and a low post state in which the upper post is disposed at a relatively low position. A position of the upper post in the low post state is posterior to a position of the upper post in the high post state. According to this, when, for example, riding up a hill, it is possible for the rider to comfortably pedal by arranging the seat post in the high post state. Further, for example, when riding down a bumpy hill, it becomes easy for the rider to move the body in accordance with the bumps by arranging the seat post in the low post state.
(4) In the seat support device in (3), when the seat post is in the high post state, a position of the second support shaft which supports the coupling arm is lower than a height of an upper end of the upper post. According to this position of the second support shaft, when lowering the position of the upper post, the upper post moves rearward.
(5) In the seat support device described in any one of (1) through (4), a clamp member is attached to the upper post, and a rear end of the coupling arm is coupled to the clamp member via a coupling shaft.
(6) In the seat support device in (5), the coupling arm bulges below a straight line connecting the coupling shaft and the second support shaft. This makes it possible for the rider to smoothly dismount forward from the seat.
(7) A bicycle proposed in the present disclosure includes the seat support device described in any one of (1) through (6).
(8) The bicycle described in (7) further includes a frame. The frame includes a head tube configured to support a steering shaft, a frame bottom part configured to support a bottom bracket configured to support a crankshaft, and a mainframe part which extends rearward from the head tube to be coupled to the frame bottom part. The lower post is coupled to the mainframe part via the first support shaft.
(9) In the bicycle described in (8), the seat post is configured to move between a high post state in which the upper post is disposed at a relatively high position, and a low post state in which the upper post is disposed at a relatively low position, and when the seat post is in the low post state, the seat post tilts rearward beyond the mainframe part.
(10) The bicycle described in any one of (7) through (9) further includes a frame, wherein the frame includes a head tube configured to support a steering shaft, and a mainframe part extending rearward from the head tube, and the coupling arm is coupled to the mainframe part via the second support shaft.
(11) The bicycle described in any one of (7) through (10) further includes a frame, wherein the frame includes a head tube configured to support a steering shaft, and a mainframe part extending rearward from the head tube, the mainframe part includes a right extension part and a left extension part separated in a left-right direction, and the coupling arm is at least partially disposed between the right extension part and the left extension part. According to this structure, it becomes easy to avoid interference between the coupling arm and the mainframe part, and it is possible to increase the degree of freedom regarding the position, the shape, and the movable range of the coupling arm.
(12) The bicycle described in any one of (7) through (11) further includes a frame, wherein the frame includes a head tube configured to support a steering shaft, and a mainframe part extending rearward from the head tube, the mainframe part includes a right extension part and a left extension part separated in a left-right direction, and the seat post is at least partially disposed between the right extension part and the left extension part. According to this structure, it becomes easy to avoid interference between the seat post and the mainframe part, and it is possible to increase the degree of freedom regarding the position and the movable range of the seat post.

### BRIEF DESCRIPTION OF THE DRAWINGS

FIG. 1 is a side view of a bicycle proposed in the present disclosure.

FIG. 2 is a perspective view showing a rear part of the bicycle.

FIG. 3 is a perspective view illustrating a support structure for a motor unit, a bottom bracket, and so on. In this drawing, a right extension portion of a mainframe part is omitted.

FIG. 4 is a side view showing the rear part of the bicycle.

FIG. 5 is a schematic side view showing a positional relationship of the motor unit, the bottom bracket, a battery, and so on.

FIG. 6 is a side view of a seat support structure.

FIG. 7 is a side view of showing a motion of the seat support structure.

### DETAILED DESCRIPTION OF THE INVENTION

The present disclosure is to be considered as an exemplification of the invention, and is not intended to limit the invention to the specific embodiments illustrated by the figures or description below. The present invention will now be described by referencing the appended figures representing embodiments.

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises”, “comprising”, “includes”, and/or “including”, when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of technologies are disclosed. Each of these has individual benefit and each can also be used in conjunction with one or more, or in some cases all, of the other disclosed technologies. Accordingly, for the sake of clarity, this description will refrain from repeating every possible combination of the individual technologies in an unnecessary fashion. Nevertheless, the specification and claims should be read with the understanding that such combinations are entirely within the scope of the invention and the claims.

In the following description, for purposes of explanation, numerous specific details are set forth in order to provide a thorough understanding of the present invention. It will be evident, however, to one skilled in the art that the present invention may be practiced without these specific details.

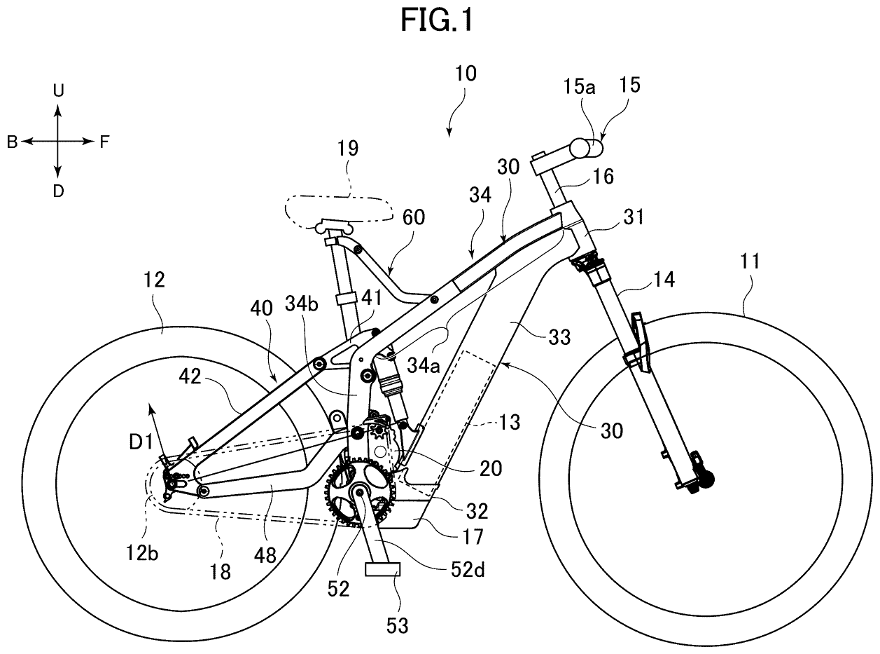

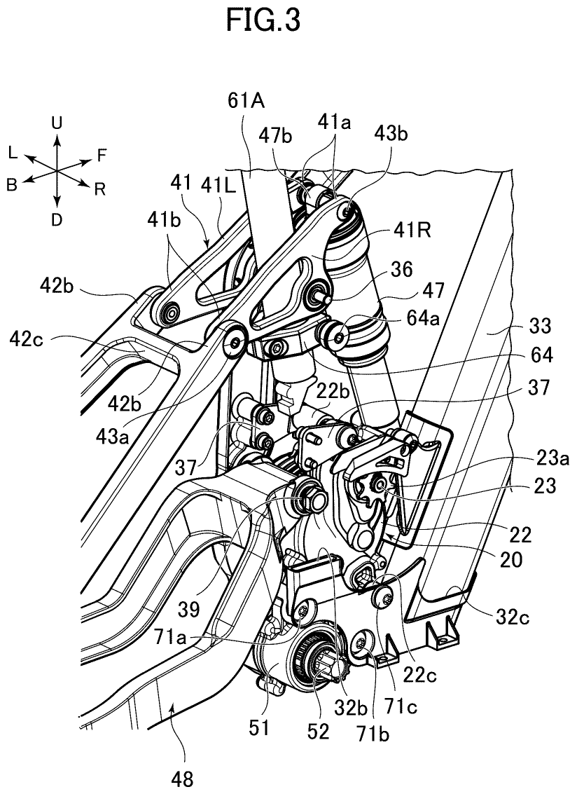

An electric power-assisted bicycle shown in FIG. 1 and so on will hereinafter be described as an example of the bicycle proposed in the present disclosure. It should be noted that in the following description, the direction F and the direction B shown in FIG. 1 and so on are referred to as a forward direction and a backward direction, respectively. Further, the direction U and the direction D shown in FIG. 1 and so on are referred to as an upward direction and a downward direction, respectively. Further, the direction L and the direction R shown in FIG. 3 are referred to as a leftward direction and a rightward direction, respectively.

As shown in FIG. 1, a bicycle 10 includes a motor unit 20, a battery 13, and a frame 30. Further, the bicycle 10 includes a seat 19 and a seat support device 60.

### [Support Structure of Frame and Crankshaft]

As shown in FIG. 1, the frame 30 includes a head tube 31 for supporting a steering shaft 16 at the foremost part of the frame 30. A steering handle 15 is fixed to an upper portion of the steering shaft 16. The steering handle 15 includes grips 15a in a right portion and a left portion thereof. A front fork 14 is fixed to a lower portion of the steering shaft 16. A front wheel 11 is supported at a lower end of the front fork 14.

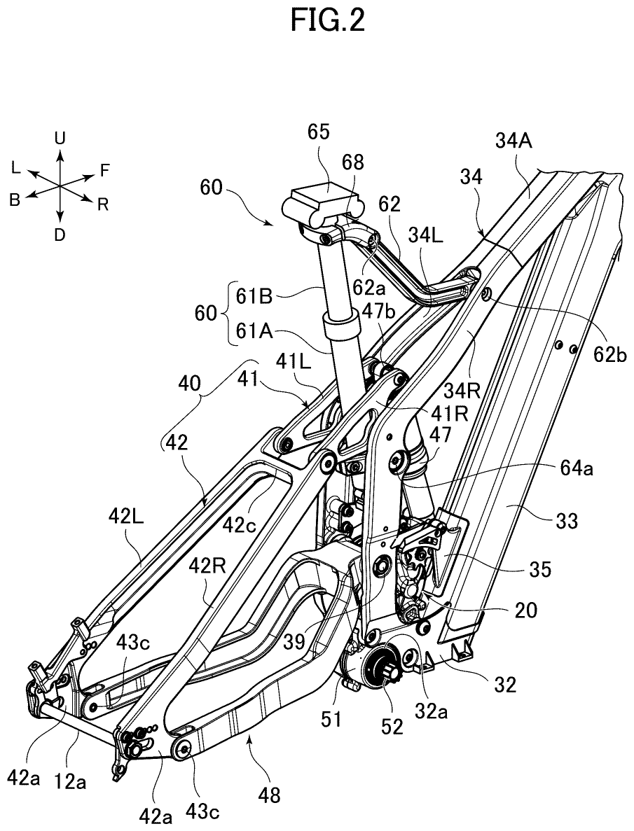

As shown in FIG. 1, the bicycle 10 includes a bottom bracket 51 (see FIG. 2) which rotatably holds a crankshaft 52. The bottom bracket 51 has a substantially cylindrical shape, and the crankshaft 52 is inserted inside the bottom bracket 51. The crankshaft 52 includes crank arms 52d at a right end and a left end thereof. A pedal 53 is fixed to an end portion of the crank arm 52d.

As shown in FIG. 2, the frame 30 includes a frame bottom part 32 to which the bottom bracket 51 is attached. The frame bottom part 32 is located in a lower end portion of the frame 30. The bottom bracket 51 is disposed at, for example, a lower side of a rearmost portion of the frame bottom part 32. A recessed part 32a is formed in the rearmost portion of the frame bottom part 32. The bottom bracket 51 may be disposed in this recessed part 32a. The bottom bracket 51 is fixed to a lower portion of the frame bottom part 32 with fastening members 71a and 71b (see FIG. 3), which are fasteners such as a bolt or a screw. The bottom bracket 51 may be welded to the frame bottom part 32.

As shown in FIG. 1, the frame 30 includes a down frame part 33 extending obliquely backward and downward from the head tube 31 toward the frame bottom part 32. An upper end (a front end) of the down frame part 33 is welded to the head tube 31. Further, a lower end (a rear end) of the down frame part 33 is welded to the frame bottom part 32. The down frame part 33 and the frame bottom part 32 (a portion supporting the bottom bracket 51) may be formed integrally with each other.

As shown in FIG. 1, the frame 30 includes a mainframe part 34 extending rearward from the head tube 31. A front part 34a of the mainframe part 34 is located above the down frame part 33. In the example shown in FIG. 1, the front part 34a of the mainframe part 34 extends obliquely rearward and downward from the head tube 31. The mainframe part 34 bends at a rear end of the front part 34a, and a rear part 34b of the mainframe part 34 extends downward toward the frame bottom part 32. The bottom bracket 51 is located below the lower end of the mainframe part 34 (extension parts 34R and 34L which are described later).

The shape of the mainframe part 34 is not limited to the example shown in the drawing. For example, the mainframe part 34 may extend from, for example, the head tube 31 toward the frame bottom part 32 while gently curving.

As shown in FIG. 2 and FIG. 3, the lower end of the mainframe part 34 is coupled to an upper end 32b (see FIG. 3) of a rear portion of the frame bottom part 32. The lower end of the down frame part 33 is coupled to an upper end 32c (see FIG. 3) of a front portion of the frame bottom part 32. The bottom bracket 51 is fixed to a lower side of the rearmost portion of the frame bottom part 32.

The structure of the frame 30 is not limited to the example shown in FIG. 1 and so on. For example, the frame bottom part 32 may be provided with a through hole penetrating the frame bottom part 32 in a left-right direction. Further, the bottom bracket 51 may be fitted into this through hole to be supported by the frame bottom part 32. On this occasion, the frame bottom part 32 may be a cylindrical portion. Further, the lower end of the mainframe part 34 may be coupled to an outer circumferential surface of the frame bottom part 32, or the lower end (the rear end) of the down frame part 33 may be coupled to the outer circumferential surface of the frame bottom part 32. Further, a stay for supporting an axle 12a of a rear wheel 12 may be provided to the frame 30 instead of a rear arm 48 described later. This stay may also be coupled to the frame bottom part 32 having the cylindrical shape.

Further, the mainframe part 34 may be formed of a tube extending rearward from the head tube 31, and a tube extending downward from a rear end of this tube. In other words, the mainframe part 34 may be formed of the two tubes coupled to each other. Further, the down frame part 33 extends straight from the head tube 31 in the example shown in FIG. 2 and so on, but may have a bend part in the middle unlike the example. For example, the down frame part 33 may extend obliquely rearward and downward from the head tube 31, and then bend rearward in a lowermost portion of the down frame part 33 to be coupled to the frame bottom part 32.

### [Support Structure of Rear Wheel]

As shown in FIG. 2, the bicycle 10 has the rear arm 48. A front end of the rear arm 48 is coupled to the mainframe part 34 via a pivot shaft 39. The front end of the rear arm 48 is disposed between the right extension part 34R and the left extension part 34L (to be described later) of the mainframe part 34. The axle 12a of the rear wheel 12 is supported by the rearmost portion of the rear arm 48. The rear arm 48 can move up and down centering on the pivot shaft 39.

As shown in FIG. 2, the bicycle 10 includes a rear suspension 47, and a link mechanism 40 for coupling the rear suspension 47 and the rear arm 48 to each other. The rear suspension 47 is disposed between, for example, the rear part 34b of the mainframe part 34 and the down frame part 33. A lower end of the rear suspension 47 is attached to the down frame part 33 via a bracket 35. The link mechanism 40 is coupled to an upper end of the rear suspension 47.

As shown in FIG. 2, the link mechanism 40 includes, for example, a first link member 41 and a second link member 42. When the bicycle 10 runs on a bumpy road, an impact which acts on the rear wheel 12 is propagated to the rear suspension 47 via the link members 41 and 42.

As shown in FIG. 3, foremost parts 41a of the first link member 41 are coupled to an upper end of the rear suspension 47 via a coupling shaft 43b. Rearmost parts 41b of the first link member 41 are coupled to foremost parts 42b of the second link member 42 via coupling shafts 43a. The first link member 41 can swing back and forth centering on a support shaft 36 supported by the mainframe part 34. The first link member 41 includes a link right part 41R and a link left part 41L each including the rearmost part 41b and the foremost part 41a.

As shown in FIG. 2, a rearmost part 42a of the second link member 42 supports the axle 12a of the rear wheel 12. Further, a rear end of the rear arm 48 is coupled to the rearmost part 42a of the second link member 42 via a coupling shaft 43c. The second link member 42 extends obliquely upward and forward from the rearmost part 42a. The second link member 42 includes a link right part 42R and a link left part 42L each including the rearmost part 42a and the foremost part 42b.

### [Motor Unit]

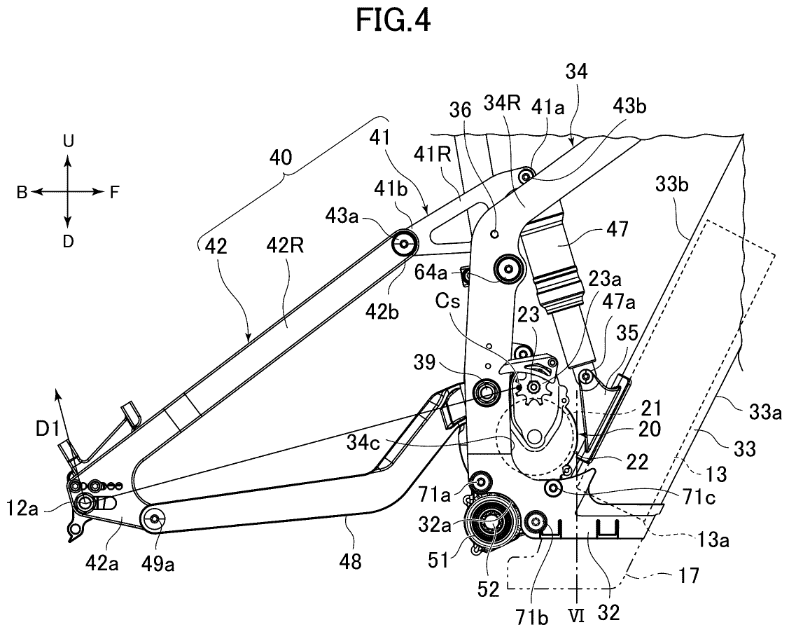

As shown in FIG. 3, the motor unit 20 includes an electric motor 21 (see FIG. 4), a housing 22 which houses the electric motor 21, and an output shaft 23 for outputting the torque of the electric motor 21. The output shaft 23 protrudes rightward from the housing 22. To the output shaft 23, there is attached a sprocket 23a. The motor unit 20 may house a reduction gear in addition to the electric motor 21. The rotation of the electric motor 21 may be transmitted to the output shaft 23 via the reduction gear.

As shown in FIG. 3, the bottom bracket 51 and the motor unit 20 are disposed at a distance. In other words, the bottom bracket 51 is not a member housed in the housing 22. This makes it possible to increase the degree of freedom of the layout of the motor unit 20 in comparison with the structure in which the bottom bracket 51 and the motor unit 20 are unitized, that is the structure in which the electric motor 21, the output shaft 23, and the bottom bracket 51 are housed in a single housing. In the example shown in FIG. 3, the motor unit 20 is disposed at a position away from and upward from the bottom bracket 51.

### [Structure for Torque Transmission]

As shown in FIG. 1, the bicycle 10 includes a chain 18. The chain 18 is wound around the sprocket 23a provided to the output shaft 23, a sprocket 52a provided to the crankshaft 52, and a sprocket 12b provided to the axle of the rear wheel 12. The torque of the crankshaft 52 and the torque of the output shaft 23 are transmitted to the rear wheel 12 via the chain 18.

The number of teeth of the sprocket 23a provided to the output shaft 23 is smaller than the number of teeth of the sprocket 12b of the rear wheel 12. Further, the number of teeth of the sprocket 23a is smaller than the number of teeth of the sprocket 52a of the crankshaft 52. Thus, the rotation of the output shaft 23 is reduced and is transmitted to the rear wheel 12 and the crankshaft 52.

In the structure in which the motor unit and the bottom bracket are unitized, the rotation of the electric motor is transmitted to the crankshaft via a plurality of gears. In order to ensure a sufficient reduction ratio in this structure, it is necessary to attach a gear with a large number of teeth (a gear large in diameter) to the crankshaft. This makes the structure around the crankshaft large in size, that is, the housing which houses the motor unit and so on grows in size, and therefore, it is necessary to increase the distance between the axle of the rear wheel and the crankshaft.

In contrast, in the bicycle 10, since the rotation of the output shaft 23 is reduced by the sprockets 23a, 12b, and 52a, and the chain 18, there is no need to attach the gear large in diameter described above to the crankshaft 52. As a result, it is possible to shorten the distance between the axle 12a of the rear wheel 12 and the crankshaft 52. Thus, it is possible to decrease the inertia moment around the axle of the rear wheel 12, and thus, it is possible to easily perform a posture change (e.g., wheelie) of the bicycle 10. In the example shown in FIG. 1, the rear wheel 12 is close to the rear part 34b of the mainframe part 34, and the foremost portion of the rear wheel 12 overlaps the sprocket 52a of the crankshaft 52 in a side view.

It should be noted that the bicycle may include speed change gears. In this case, the axle 12a of the rear wheel 12 may be provided with a plurality of sprockets 12b, which have a different number of teeth from each other. Further, the bicycle 10 may include a derailleur mechanism for moving the chain 18 to the sprocket 12b corresponding to the speed change gear set.

### [Control of Electric Motor]

The battery 13 is electrically coupled to the electric motor 21, and the electric motor 21 is driven by a current of the battery 13. The bicycle 10 includes a control device for controlling the electric motor 21 and a drive device for supplying power of the battery 13 to the electric motor 21 (both the devices are not shown). Further, the bicycle 10 includes a torque sensor for detecting the torque (tread force acting on the pedal 53) acting on the crankshaft 52, and a vehicle speed sensor for detecting the vehicle speed (both the sensors are not shown). The torque sensor is provided to, for example, the crankshaft 52. The vehicle speed sensor is provided to the front wheel 11 or the rear wheel 12.

The control device calculates an assist rate based on an output of the vehicle speed sensor to calculate a command value of the current based on the assist rate and an output of the torque sensor. The drive device supplies the current according to the command value to the electric motor 21. The control device and the drive device are housed in an electric component case 17 (see FIG. 1) attached to, for example, the lower end of the down frame part 33. An arrangement of the control device and the drive device is not limited to the example described here.

### [Layout of Motor Unit and Battery]

The battery 13 is attached to the down frame part 33. As shown in FIG. 4, the battery 13 may be housed in the down frame part 33. More specifically, the down frame part 33 has a box-like shape elongated in the extending direction thereof (obliquely rearward and downward), and the battery 13 may be disposed inside the down frame part 33.

In order to make such a layout of the battery 13, the frame 30 may include an opening for inserting the battery 13. For example, the down frame part 33 and the frame bottom part 32 may be provided with an opening at a lower side thereof. Further, the battery 13 may be able to be inserted inside the down frame part 33 through the opening. The opening may be closed by the electric component case 17.

The arrangement of the battery 13 is not limited to the example shown in FIG. 4. For example, the battery 13 may be attached to a front surface 33a of the down frame part 33. Conversely, the battery 13 may be attached to a rear surface 33b of the down frame part 33. Further, the opening for inserting the battery 13 inside the down frame part 33 may be provided to the rear surface 33b of the down frame part 33.

As still another structure, a recessed part opening forward may be provided to the down frame part 33. The battery 13 may be disposed in this recessed part. Conversely, a recessed part opening rearward may be provided to the down frame part 33. The battery 13 may be housed in this recessed part.

The electric component case 17 (see FIG. 1) is located below the motor unit 20 and the battery 13. This can shorten the distance between a circuit board (the control device and/or the drive device) housed in the electric component case 17 and the electric motor 21, and the distance between this circuit board and the battery 13. The positions of the control device and the drive device may be higher than the sprocket 52a of the crankshaft 52.

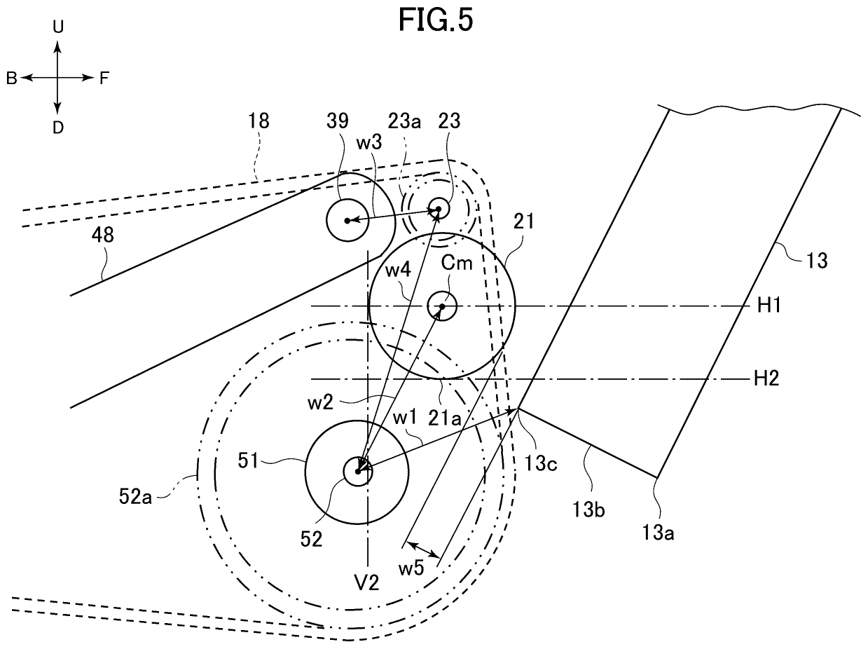

As shown in FIG. 2, the motor unit 20 is located above the bottom bracket 51 and behind the battery 13. As shown in FIG. 4, at least a lower end 13a of the battery 13 is located below a rotational center Cm of the electric motor 21. In other words, at least the lower end 13a of the battery 13 is located below a horizontal line H1 (see FIG. 5) passing through the rotational center Cm. In FIG. 4, the lower end 13a of the battery 13 is a lower end (corner) of the front surface of the battery 13.

According to such a layout of the motor unit 20, the battery 13, and the bottom bracket 51, it is possible to use a space formed at an obliquely front and lower side of the motor unit 20 for an arrangement of the battery 13. This can shorten the distance between the crankshaft 52 located below the motor unit 20 and the battery 13 to decrease the inertia moment of the bicycle 10 around the crankshaft 52. As a result, the posture change of the bicycle 10 by an operation of a rider when riding on irregular ground, can be made easier.

As shown in FIG. 5, in the bicycle 10, not only the lower end 13a of the battery 13 but also the whole of a lower surface 13b is located below the rotational center Cm of the electric motor 21. In other words, the whole of the lower surface 13b is located below the horizontal line H1 (see FIG. 5) passing through the rotational center Cm. By lowering the position of the battery 13 in such a manner, the distance between the battery 13 and the crankshaft 52 can further be shortened.

As shown in FIG. 5, in the bicycle 10, the whole of the lower surface 13b of the battery 13 is located lower than a lower end 21a of the electric motor 21. In other words, the whole of the lower surface 13b of the battery 13 is lower than the horizontal line H2 passing through the lower end 21a of the electric motor 21. Accordingly, the distance between the battery 13 and the crankshaft 52 can further be reduced.

As described above, in the bicycle 10, the battery 13 is housed in the down frame part 33 as shown in FIG. 4. Due to this structure, it becomes possible to make the distance between the battery 13 and the crankshaft 52 shorter in comparison with, for example, a structure in which the battery 13 is attached to the front surface 33a of the down frame part 33.

It should be noted that the positional relationship between the battery 13 and the motor unit 20 is not limited to the example shown in FIG. 3. For example, the position of a part of the lower surface 13b of the battery 13 may be higher than the horizontal line H2 passing through the lower end 21a of the electric motor 21.

Further, the battery 13 may be attached to the rear surface 33b of the down frame part 33, and the lower end 13a thereof may be located below the rotational center Cm of the electric motor 21. In this case, the down frame part 33 may be formed so as to allow such an arrangement of the battery 13.

As shown in FIG. 5, the distance W1 from the center of the crankshaft 52 to an end portion 13c of the battery 13 is smaller than the distance W2 from the crankshaft 52 to the rotational center Cm of the electric motor 21. (In the description here, the end portion 13c of the battery 13 means a rear end of a lower portion of the battery 13.)

In the example shown in FIG. 5, the motor unit 20 is disposed so that the position of the output shaft 23 is higher than the electric motor 21. Therefore, the distance W1 is smaller than the distance from the crankshaft 52 to the output shaft 23.

It should be noted that the distance W1 may be smaller than only either one of the distance W2 from the crankshaft 52 to the rotational center Cm of the electric motor 21 and a distance from the crankshaft 52 to the output shaft 23 depending on the posture (the positional relationship between the electric motor 21 and the output shaft 23) of the motor unit 20.

The space formed below the motor unit 20 is used for the layout of the battery 13 and the electric component case 17. Therefore, as shown in FIG. 4, a vertical line V1 passing through the front end of the motor unit 20 may cross the rear portion of the battery 13. Further, the vertical line V1 may also cross the electric component case 17.

As described above, the position of the battery 13 and the position of the motor unit 20 are close to each other. More specifically, as shown in FIG. 5, the distance W3 between the outer circumferential surface of the electric motor 21 and the battery 13 may be smaller than the radius of the electric motor 21.

### [Arrangement of Motor Unit and Rear Suspension]

As shown in FIG. 4, the bracket 35 which supports a lower end of the rear suspension 47 is located between the motor unit 20 and the lower portion of the battery 13. In particular, the horizontal line H1 (see FIG. 5) passing through the rotational center Cm of the electric motor 21 crosses the bracket 35 and the lower portion of the battery 13. As described above, the bracket 35 is disposed using a space (in other words, a space between the motor unit 20 and the down frame part 33) between the motor unit 20 and the battery 13.

As shown in FIG. 4, a lower end 47a of the rear suspension 47 is located in front of the motor unit 20. Further, an upper end 47b (see FIG. 2) of the rear suspension 47 is located above the motor unit 20.

As shown in FIG. 4, the motor unit 20 is disposed so that the output shaft 23 is located above the electric motor 21. This can lower the position of the electric motor 21, which is heavy, which can decrease the inertia moment around the crankshaft 52. As a result, the posture change of the bicycle 10 by an operation of a rider, when riding on irregular ground, can be made easier.

### [Relative Position Between Motor Unit and Frame]

As shown in FIG. 2, the mainframe part 34 is branched into two in the middle thereof. In other words, the mainframe part 34 includes the right extension part 34R and the left extension part 34L separated in the left-right direction. The mainframe part 34 includes a first extension part 34A which is coupled to the head tube 31. The left and right extension parts 34L and 34R extend obliquely rearward and downward from the first extension part 34A. Subsequently, the extension parts 34L and 34R each bend and extend downward. The extension parts 34L and 34R form a part of the front part 34a (see FIG. 1) and the rear part 34b (see FIG. 1) of the mainframe part 34 described above. The lower end of each of the extension parts 34R and 34L is coupled to the upper end 32b (see FIG. 3) of a rear portion of the frame bottom part 32.

The motor unit 20 may be disposed so as to overlap a part of either one or both the of the extension parts 34R and 34L in a side view of the bicycle 10. As shown in FIG. 4, in the bicycle 10, the motor unit 20 is disposed so that the rearmost part of the electric motor 21 overlaps the right extension part 34R.

According to this arrangement of the motor unit 20, it is possible to displace the position of the motor unit 20 rearward up to the positions of the extension parts 34R and 34L. In this way, it becomes easy to shorten the distance between the battery 13 disposed at the front side of the motor unit 20 and the crankshaft 52.

The positional relationship between the motor unit 20 and the extension parts 34R and 34L is not limited to the example described above. For example, a recessed part may be provided to a front surface 34c (see FIG. 4) of either one or both of the extension parts 34R and 34L, and a part of the motor unit 20 may be provided to the recessed part. For example, the recessed part may be provided to the left extension part 34L, and a part of the motor unit 20 may be provided to the recessed part. This structure can also displace the position of the motor unit 20 rearward. Also in this case, the right extension part 34R may overlap the rearmost part of the electric motor 21 without providing such a recessed part to the right extension part 34R.

Unlike the above, the rearmost part of the motor unit 20 may be disposed between the left and right extension parts 34L and 34R. In other words, the rearmost part of the motor unit 20 may overlap both the left and right extension parts 34L and 34R in the side view of the vehicle. Unlike the above, the recessed part may be provided to both the left and right extension parts 34L and 34R.

As a result of the fact that the position of the motor unit 20 is shifted rearward in such a manner, the vertical line V2 (see FIG. 5) passing through the rear end of the electric motor 21 crosses the bottom bracket 51. As a result, it becomes easy to shorten the distance between the battery 13 and the crankshaft 52. As shown in FIG. 1, the whole of the motor unit 20 may be located forward of a rear end of the sprocket 52a of the crankshaft 52. Further, the whole of the motor unit 20 may be located forward of the rear surface of the extension parts 34R and 34L.

[Support Structure of Motor Unit with Frame]

The motor unit 20 is supported by the frame 30. As shown in FIG. 3, the housing 22 of the motor unit 20 includes an attachment target part 22b in an uppermost part of the housing 22. The attachment target part 22b is fixed to the left and right extension parts 34L and 34R with a fastening part (e.g., a screw) via a bracket 37. Further, the housing 22 includes an attachment target part 22c in a lowermost part thereof. The attachment target part 22c is fixed to the frame bottom part 32 with a fastening part (e.g., a screw). The attachment target part 22c of the housing 22 may be fixed to the down frame part 33.

### [Arrangement of Rear Arm]

As described above, the bicycle 10 has the rear arm 48 (see FIG. 2). The rear arm 48 is coupled to the mainframe part 34 via the pivot shaft 39. Therefore, the rear arm 48 is made movable upward and downward centering on the pivot shaft 39. As shown in FIG. 5, the position of the pivot shaft 39 is higher than the rotational center Cm of the electric motor 21. Making the position of the pivot shaft 39 high, as described above, results in the moving direction of the rear wheel 12 tilted rearward with respect to the vertical direction as indicated by the arrow D1 in FIG. 1 and FIG. 4 when the rear wheel 12 runs upon a protruding part on a road. As a result, an impact when the rear wheel 12 collides with the protruding part can be relaxed, and thus, it is possible for the rear wheel 12 to smoothly run upon the protruding part.

As shown in FIG. 5, the positions of both the pivot shaft 39 and the output shaft 23 of the motor unit 20 are higher than the rotational center Cm of the electric motor 21. Further, the output shaft 23 is located in front of the pivot shaft 39. More particularly, the pivot shaft 39 and the output shaft 23 may be arranged so that there exists a straight line along a front-back direction crossing both of these two shafts. For example, the pivot shaft 39 and the output shaft 23 may be located at substantively the same height. According to this layout, the distance between the pivot shaft 39 and the output shaft 23 can be shortened. In the example shown in FIG. 5, the distance W3 from the output shaft 23 of the motor unit 20 to the pivot shaft 39 is shorter than the distance W4 from the output shaft 23 to the crankshaft 52. By shortening the distance between the pivot shaft 39 and the output shaft 23 as described above, the motion of the rear wheel 12 can be made smooth. This point will hereinafter be described.

As shown in FIG. 4, the axle 12a of the rear wheel 12 is supported by the rearmost part 42a of the second link member 42 which is located posterior to the rear end of the rear arm 48. The rearmost part 42a is coupled to the rear end of the rear arm 48 via the coupling shaft 43c. Therefore, when the bicycle 10 runs on the bumpy road, the rear wheel 12 moves up and down centering on a swing center Cs (see FIG. 4) located slightly forward of the pivot shaft 39. When shortening the distance between the pivot shaft 39 and the output shaft 23, the distance between the swing center Cs and the output shaft 23 can also be shortened.

Since the position of the pivot shaft 39 is set higher than the axle 12a of the rear wheel 12 as described above, when the rear wheel 12 runs upon the protruding part on the road, the rear wheel 12 is urged to move obliquely rearward and upward (the direction D1 shown in FIG. 4). Here, when the distance between the swing center Cs (see FIG. 4) of the rear wheel 12 and the output shaft 23 is long, the distance between the axle 12a of the rear wheel 12 and the output shaft 23 increases as the position of the rear wheel 12 rises. Then, the tension acting on the chain 18 increases, and the motion of the rear wheel 12 is hindered. In contrast, by making both the pivot shaft 39 and the output shaft 23 higher than the rotational center Cm of the electric motor 21 to shorten the distance between the swing center Cs and the output shaft 23, it is possible to prevent the tension acting on the chain 18 from becoming excessive. It should be noted that the position of the swing center Cs may coincide with the position of the output shaft 23.

### [Seat Support Device]

The bicycle 10 includes the seat support device 60. As shown in FIG. 2, the seat support device 60 includes a seat post 61 and a coupling arm 62.

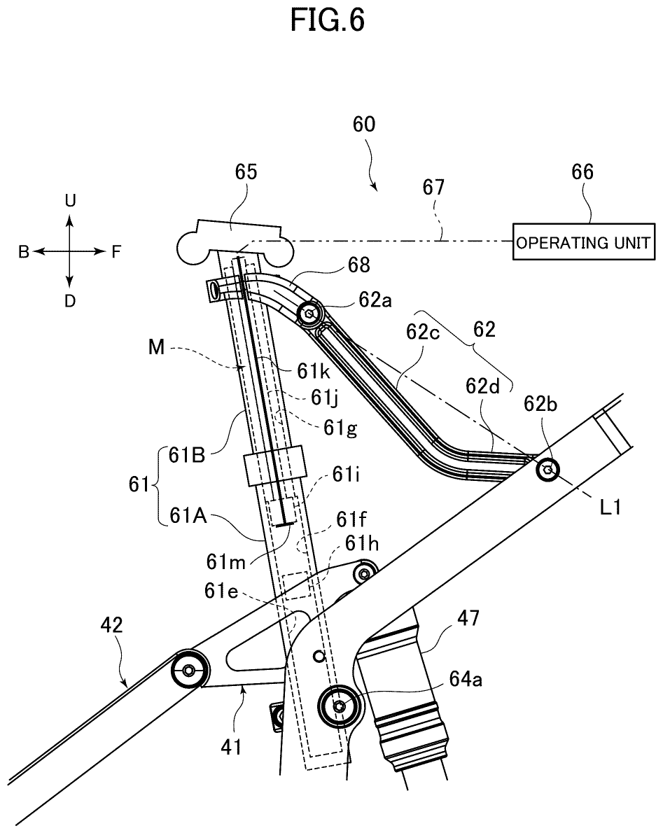

As shown in FIG. 6, the seat post 61 includes a lower post 61A and an upper post 61B. The lower post 61A can move forward and backward centering on a support shaft 64a having an axis line along the left-right direction. The support shaft 64a is located in a lower portion of the lower post 61A. As shown in FIG. 3, a clamp member 64 is fixed to the lower portion of the lower post 61A. The clamp member 64 has a ring-like shape. The lower post 61A is held by being fitted inside the clamp member 64. The clamp member 64 is supported by the mainframe part 34 via the support shaft 64a. Therefore, the lower post 61A can move forward and backward relative to the mainframe part 34 centering on the support shaft 64a. The attachment position of the clamp member 64 is not limited to the example shown in FIG. 6. The clamp member 64 may be located in or around a central portion in the vertical direction of the lower post 61A.

As shown in FIG. 6, the upper post 61B extends upward from the lower post 61A. The upper post 61B supports the seat 19 (see FIG. 1) at an upper side thereof. A seat stay 65 is attached to an upper end of the upper post 61B, and the seat 19 is attached to the seat stay 65. The upper post 61B can move upward and downward relative to the lower post 61A. In other words, the upper post 61B can move relative to the lower post 61A in a drawing direction of the seat post 61. The lower post 61A has a cylindrical shape, and the upper post 61B is inserted in the inside thereof. Conversely, the lower post 61A may be inserted in the inside of the upper post 61B.

### [Seat Position Adjustment Mechanism]

The seat post 61 includes a seat position adjustment mechanism M in the inside thereof. As shown in FIG. 6, the seat position adjustment mechanism M switches between a locked state in which the relative position between the upper post 61B and the lower post 61A is locked, and an unlocked state in which a change in the relative position between the upper post 61B and the lower post 61A is allowed. A user adjusts the position (the height) of the seat 19 in the unlocked state of the seat position adjustment mechanism M, and then, sets the seat position adjustment mechanism M to the locked state.

The seat position adjustment mechanism M includes a biasing unit for biasing the upper post 61B upward with respect to the lower post 61A in the unlocked state. The biasing unit is realized by, for example, a gas chamber 61e in which a high-pressure gas described later is trapped, and an oil chamber 61f filled with an operating oil. Further, the seat position adjustment mechanism M includes an operating unit 66 for the user to operate. The seat position adjustment mechanism M is switched between the locked state and the unlocked state due to an operation on the operating unit 66.

The seat post 61 is referred to as a dropper seat post, and the seat position adjustment mechanism M operates, for example, as follows. When setting the seat post 61 to the unlocked state with the operation on the operating unit 66, the upper post 61B automatically moves upward due to the operation of the biasing unit, and as a result, the position of the seat 19 rises. In this unlocked state, when the user pushes down the seat 19 in the teeth of the biasing force, the position of the upper post 61B (the position of the seat 19) falls. When setting the seat post 61 to the locked state with the operation on the operating unit 66, the height of the upper post 61B is fixed.

As shown in FIG. 6, the seat position adjustment mechanism M includes the gas chamber 61e, the first oil chamber 61f, and a second oil chamber 61g inside the seat post 61. The gas chamber 61e and the oil chambers 61f and 61g are zoned by a free piston 61h. Further, the first oil chamber 61f and the second oil chamber 61g are zoned by a piston 61i. The piston 61i is provided with an oil flow path. The oil can move between the first oil chamber 61f and the second oil chamber 61g via the oil flow path. A valve 61m for opening and closing the oil flow path is attached to the piston 61i. The piston 61i is fixed to a tip of a piston rod 61j. The piston rod 61j passes through the second oil chamber 61g in an upward direction. The piston rod 61j has a cylindrical shape, and a push rod 61k is disposed inside the piston rod 61j. By moving the push rod 61k in an axis line direction of the seat post 61, the valve 61m disposed in the oil flow path of the piston 61i can be operated. The push rod 61k and the operating unit 66 are coupled to each other via, for example, a cable 67, and the user can operate the push rod 61k through the operating unit 66. The operating unit 66 may be, for example, a button or a lever attached to the steering handle 15.

The seat position adjustment mechanism M operates as follows. When pushing the push rod 61k via the operating unit 66 to open the valve 61m, the seat post 61 turns to the unlocked state. On this occasion, the first oil chamber 61f and the second oil chamber 61g communicate with each other via the oil flow path formed in the piston 61i. The oil moves from the second oil chamber 61g to the first oil chamber 61f via the oil flow path due to the pressure in the gas chamber 61e, and the upper post 61B moves upward. Conversely, when the user pushes down the seat 19 in the teeth of the pressure in the gas chamber 61e, the oil moves from the first oil chamber 61f to the second oil chamber 61g via the oil flow path, and the upper post 61B moves downward.

The structure of the seat position adjustment mechanism M is not limited to the example shown in FIG. 6. The seat position adjustment mechanism M may have other structures as long as the structure is capable of switching the seat post 61 between the unlocked state and the locked state, and has the function of biasing the upper post 61B upward in at least the unlocked state.

### [Coupling Arm]

As shown in FIG. 6, a rear portion of the coupling arm 62 is coupled to the upper post 61B. In particular, a clamp member 68 (see FIG. 2) is attached to the upper post 61B. The upper post 61B is held by being fitted inside the clamp member 68. The clamp member 68 is coupled to a rear end of the coupling arm 62 via a coupling shaft 62a. The coupling shaft 62a has an axis line along the left-right direction. Due to this coupling structure, an angle between the upper post 61B and the coupling arm 62 can change in accordance with the position (the height) of the upper post 61B.

Further, as shown in FIG. 6, a support shaft 62b is disposed in front of the seat post 61. The support shaft 62b also has an axis line along the left-right direction. The foremost part of the coupling arm 62 is supported by the support shaft 62b so that the coupling arm 62 can move upward and downward centering on the support shaft 62b. The support shaft 62b is supported by the mainframe part 34. In other words, the foremost part of the coupling arm 62 is coupled to the mainframe part 34 via the support shaft 62b.

### [Motion of Seat Support Device]

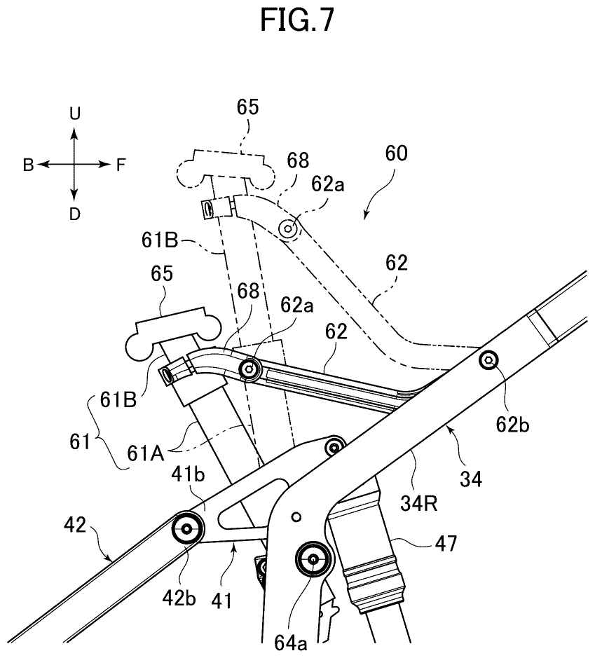

The seat post 61 can move between a high post state and a low post state. The high post state is a state in which the upper post 61B and the seat 19 are disposed at relatively high positions, and is, for example, the state (the position and the length) of the seat post 61 represented by the dashed-two dotted lines in FIG. 7. The low post state is a state in which the upper post 61B and the seat 19 are disposed at relatively low positions, and is, for example, the state (the position and the length) of the seat post 61 represented by the solid lines in FIG. 7. The seat post 61 can be arranged in an intermediate state therebetween.

As described above, the lower post 61A is supported by the support shaft 64a, and the foremost part of the coupling arm 62 is supported by the support shaft 62b. Therefore, when the seat post 61 moves between the high post state and the low post state, the position (the position in the front-back direction of the seat 19) in the front-back direction of the upper post 61B also changes. As shown in FIG. 7, the position of the upper post 61B in the low post state is posterior to the position of the upper post 61B in the high post state.

According to such a seat support device 60, when, for example, riding up a hill, it is possible for the rider to comfortably tread on the pedals 53 by arranging the seat post 61 in the high post state. Further, for example, when riding down a bumpy hill, it becomes easy for the rider to move the body in accordance with the bumps by arranging the seat post 61 in the low post state.

As described above, the lower post 61A is held by the clamp member 64, and is supported by the support shaft 64a. The clamp member 64 may be fixed to the lower post 61A with, for example, a screw. Further, the position of the clamp member 64 in the lower post 61A may be adjustable in the vertical direction by loosening the screw. By adjusting the position of the clamp member 64, it is possible to raise and lower both of the position of the seat post 61 in the high post state and the position of the seat post 61 in the low post state.

The clamp member 68 is fixed to the upper post 61B. As represented by the solid lines in FIG. 7, when the seat post 61 is in the low post state, the clamp member 68 may have contact with an upper end of the lower post 61A. In other words, a movable range of the upper post 61B may be regulated by the clamp member 68. The clamp member 68 may be fixed to, for example, an upper portion of the upper post 61B. This can ensure a sufficient movable range with respect to the seat 19.

The clamp member 68 may also be fixed to the upper post 61B with, for example, a screw. Further, the position of the clamp member 68 in the upper post 61B may be adjustable in the vertical direction by loosening the screw. By adjusting the position of the clamp member 68, it is possible to raise and lower the position of the upper post 61B in the low post state, in other words, the lowest position of the upper post 61B.

As shown in FIG. 6, when the seat post 61 is in the high post state, the position of the support shaft 62b which supports the coupling arm 62 is lower than the height of the upper end of the upper post 61B. Due to this positional relationship, when the seat post 61 moves from the high post state to the low post state, the positions of the upper end of the upper post 61B and the seat 19 move rearward as shown in FIG. 7.

### [Shape of Coupling Arm]

As shown in FIG. 6, the coupling arm 62 curves so as to bulge below a straight line L1 that connects the coupling shaft 62a located in the rear portion of the coupling arm 62 and the support shaft 62b located in the foremost part of the coupling arm 62. According to this shape of the coupling arm 62, it becomes easy for the rider to dismount in front of the seat 19 when, for example, the seat post 61 is in the high post state.

As shown in FIG. 6, the coupling arm 62 includes a rear extension part 62c and a front extension part 62d extending from the rear extension part 62c. When the seat post 61 is in the high post state, the rear extension part 62c extends obliquely forward and downward from a portion (the coupling shaft 62a) which is coupled to the clamp member 68. The front extension part 62d bends from the rear extension part 62c. The front extension part 62d extends substantially forward. The front extension part 62d may extend obliquely upward.

### [Support Structure of Coupling Arm]

As described above, the mainframe part 34 includes the right extension part 34R and the left extension part 34L. As shown in FIG. 2, the foremost part of the coupling arm 62 is disposed between the right extension part 34R and the left extension part 34L, and the support shaft 62b is supported by the extension parts 34R and 34L. In the plan view of the bicycle 10, the coupling arm 62 is located between the right extension part 34R and the left extension part 34L. According to this structure, it is possible to increase the degree of freedom regarding the position and the shape of the coupling arm 62. For example, it becomes possible to arrange the coupling arm 62 so as to partially overlap the extension parts 34R and 34L in the side view.

In the bicycle 10, as shown in FIG. 7, it is possible to arrange the coupling arm 62 so that the front extension part 62d of the coupling arm 62 overlaps the extension parts 34R and 34L when the seat post 61 is in the low post state. Further, by arranging the front extension part 62d so as to overlap the extension parts 34R and 34L, it is possible to reduce the influence of the coupling arm 62 on mounting and dismounting actions of the rider.

It should be noted that the positional relationship between the coupling arm 62 and the mainframe part 34 is not limited to the example shown in FIG. 6, FIG. 7, and so on. For example, the rear extension part 62c of the coupling arm 62 may partially overlap the extension parts 34R and 34L depending on the shape of the coupling arm 62 and the position (the height) of the mainframe part 34.

### [Support Structure of Seat Post]

As shown in FIG. 2 and FIG. 3, the support shaft 64a of the clamp member 64 for holding the seat post 61 is disposed between the left extension part 34L and the right extension part 34R of the mainframe part 34, and is supported by these extension parts 34L and 34R. Further, a lower portion of the seat post 61 is disposed between the right extension part 34R and the left extension part 34L.

According to this arrangement of the seat post 61 and the mainframe part 34, it becomes easy to increase the degree of freedom regarding the position of the seat post 61. For example, it becomes possible to arrange the seat post 61 in a posture of overlapping the left and right extension parts 34L and 34R in the side view. As a result, it becomes possible to increase the degree of freedom of the position in the front-back direction of the seat 19. In the example shown in FIG. 6 and FIG. 7, the lowermost part of the lower post 61A overlaps a bend part between the front part 34a and the rear part 34b of the mainframe part 34.

As shown in FIG. 7, the rear part 34b (rear portions of the extension parts 34R and 34L) of the mainframe part 34 extends substantially downward toward the frame bottom part 32. When the seat post 61 is in the low post state, the seat post 61 tilts further rearward than the extension direction of the rear part 34b of the mainframe part 34. This makes it possible to move the seat 19 rearward beyond the mainframe part 34 when the seat post 61 is in the low post state.

As shown in FIG. 2, the second link member 42 includes the link right part 42R and the link left part 42L. Each of the link right part 42R and the link left part 42L includes the rearmost part 42a and the foremost part 42b (see FIG. 3) described above. As shown in FIG. 3, the foremost part 42b of the link right part 42R and the foremost part 42b of the link left part 42L are bridged with a cross part 42c. Further, the first link member 41 also includes the link right part 41R and the link left part 41L. The rearmost part 41b of the link right part 41R and the rearmost part 41b of the link left part 41L of the first link member 41 are respectively coupled to the foremost part 42b of the link right part 42R and the foremost part 42b of the link left part 42L of the second link member 42 via the coupling shafts 43a. The foremost part 41a of the link right part 41R and the foremost part 41a of the link left part 41L of the first link member 41 are coupled to the upper end 47b of the rear suspension 47 via the coupling shaft 43b.

The seat post 61 is disposed between the link right part 41R and the link left part 41L of the first link member 41. Further, the seat post 61 is located between the upper end 47b of the rear suspension 47 and the cross part 42c of the second link member 42, and can move in the front-back direction between the upper end 47b and the cross part 42c.

### Conclusion

(1) The seat support device 60 proposed in the present disclosure includes the seat post 61 which includes the lower post 61A supported so as to move forward and rearward centering on the support shaft 64a, and the upper post 61B extending upward from the lower post 61A, the upper post 61B being configured to support the seat located at the upper side of the upper post 61B and movable upward and downward relatively to the lower post 61A, the seat position adjustment mechanism M configured to switch between the locked state in which the relative position between the upper post 61B and the lower post 61A is locked, and the unlocked state in which the change in the relative position between the upper post 61B and the lower post 61A is allowed, and the coupling arm 62 coupled to the upper post 61B. The foremost part of the coupling arm 62 is supported by the support shaft 62b so that the coupling arm 62 and the upper post 61B can move upward and downward centering on the support shaft 62b located in front of the seat post 61.

According to this structure, it is possible to change the position of the seat 19 not only in the vertical direction, but also in the front-back direction.
(2) In the seat support device 60 described in (1), the seat position adjustment mechanism M includes the biasing unit configured to bias the upper post 61B upward with respect to the lower post 61A in the unlocked state, and is configured to switch between the locked state and the unlocked state in accordance with an operation on the operating unit 66 by the user. This makes it possible to easily perform the adjustment of the seat position.
(3) In the seat support device 60 described in (1) or (2), the seat post 61 is configured to move between the high post state in which the upper post 61B is disposed at a relatively high position, and the low post state in which the upper post 61B is disposed at a relatively low position. The position of the upper post 61B in the low post state is posterior to the position of the upper post 61B in the high post state. According to this, when, for example, riding up a hill, it is possible for the rider to comfortably pedal by arranging the seat post 61 in the high post state. Further, for example, when riding down a bumpy hill, it becomes easy for the rider to move the body in accordance with the bumps by arranging the seat post 61 in the low post state.
(4) In the seat support device 60 in (3), when the seat post 61 is in the high post state, the position of the support shaft 62b which supports the coupling arm 62 is lower than the height of the upper end of the upper post 61B. According to this position of the support shaft 62b, when lowering the position of the upper post 61B, the position of the upper post 61B is shifted rearward.
(5) In the seat support device 60 described in any one of (1) through (4), the clamp member 68 is attached to the upper post 61B, and the rear end of the coupling arm 62 is coupled to the clamp member 68 via the coupling shaft 62a.
(6) In the seat support device 60 in (5), the coupling arm 62 bulges below the straight line L1 connecting the coupling shaft 62a and the support shaft 62b. This makes it possible for the rider to smoothly dismount forward from the seat 19.
(7) The bicycle 10 proposed in the present disclosure includes the seat support device 60 described in any one of (1) through (6).
(8) The bicycle 10 described in (7) further includes the frame 30. The frame 30 includes the head tube 31 configured to support the steering shaft 16, the frame bottom part 32 configured to support the bottom bracket 51 configured to support the crankshaft 52, and the mainframe part 34 which extends rearward from the head tube 31 to be coupled to the frame bottom part 32. The lower post 61A is coupled to the mainframe part 34 via the support shaft 64a.
(9) In the bicycle 10 described in (8), the seat post 61 is configured to move between the high post state in which the upper post 61B is disposed at a relatively high position, and the low post state in which the upper post 61B is disposed at a relatively low position, and when the seat post 61 is in the low post state, the seat post 61 tilts rearward beyond the mainframe part 34.
(10) In the bicycle 10 described in any one of (7) through (9), the bicycle 10 further includes the frame 30, the frame 30 includes the head tube 31 configured to support the steering shaft 16, and the mainframe part 34 extending rearward from the head tube 31, and the coupling arm 62 is coupled to the mainframe part 34 via the support shaft 62b.
(11) In the bicycle 10 described in any one of (7) through (10), the bicycle 10 further includes the frame 30, the frame 30 includes the head tube 31 configured to support the steering shaft 16, and the mainframe part 34 extending rearward from the head tube 31, the mainframe part 34 includes the right extension part 34R and the left extension part 34L separated in the left-right direction, and the coupling arm 62 is at least partially disposed between the right extension part 34R and the left extension part 34L. According to this structure, it becomes easy to avoid interference between the coupling arm 62 and the mainframe part 34, and it is possible to increase the degree of freedom regarding the position, the shape, and the movable range of the coupling arm 62.
(12) In the bicycle 10 described in any one of (7) through (11), the bicycle 10 further includes the frame 30, the frame 30 includes the head tube 31 configured to support the steering shaft 16, and the mainframe part 34 extending rearward from the head tube 31, the mainframe part 34 includes the right extension part 34R and the left extension part 34L separated in the left-right direction, and the seat post 61 is at least partially disposed between the right extension part 34R and the left extension part 34L. According to this structure, it becomes easy to avoid interference between the seat post 61 and the mainframe part 34, and it is possible to increase the degree of freedom regarding the position and the movable range of the seat post 61.

### Other Issues

The bicycle proposed in the present disclosure is not limited to the electric power-assisted bicycle 10 described with reference to FIG. 1 and so on.

For example, the bicycle proposed in the present disclosure is not required to be an electric power-assisted bicycle. In other words, the bicycle proposed in the present disclosure is not required to include the motor unit 20 and the battery 13.

For example, the mainframe part 34 is not necessarily required to be branched into two. In other words, the mainframe part 34 is not required to include the right and left extension parts 34R, 34L.

The seat position adjustment mechanism M is not required to include the biasing unit (the gas chamber 61f, the oil chambers 61f, 61g, and so on) which biases the upper post 61B upward. In this case, it may be possible to change the relative position between the upper post 61B and the lower post 61A in the vertical direction with a device such as a screw mechanism, or to lock the relative position between the upper post 61B and the lower post 61A.

Although the present invention has been illustrated and described herein with reference to embodiments and specific examples thereof, it will be readily apparent to those of ordinary skill in the art that other embodiments and examples may perform similar functions and/or achieve like results. All such equivalent embodiments and examples are within the spirit and scope of the present invention, are contemplated thereby, and are intended to be covered by the following claims.

What is claimed is:

1. A seat support device comprising:
a seat post which includes a lower post supported so as to move forward and rearward centering on a first support shaft, and an upper post extending upward from the lower post, the upper post being configured to support a seat located at an upper side of the upper post and movable upward and downward relative to the lower post;
a seat position adjustment mechanism configured to switch between a locked state in which a relative position between the upper post and the lower post is locked, and an unlocked state in which a change in the relative position between the upper post and the lower post is allowed; and
a coupling arm coupled to the upper post, wherein
a foremost part of the coupling arm is supported by a second support shaft located in front of the seat post so that the coupling arm and the upper post are movable upward and downward centering on the second support shaft.

2. The seat support device according to claim 1, wherein
the seat position adjustment mechanism includes a biasing unit configured to bias the upper post upward with respect to the lower post in the unlocked state, and is configured to switch between the locked state and the unlocked state in accordance with an operation on an operating unit by a user.

3. The seat support device according to claim 1, wherein
the seat post is configured to move between a high post state in which the upper post is disposed at a relatively high position, and a low post state in which the upper post is disposed at a relatively low position, and
a position of the upper post in the low post state is posterior to a position of the upper post in the high post state.

4. The seat support device according to claim 3, wherein
when the seat post is in the high post state, a position of the second support shaft which supports the coupling arm is lower than a height of an upper end of the upper post.

5. The seat support device according to claim 1, wherein
a clamp member is attached to the upper post, and
a rear end of the coupling arm is coupled to the clamp member via a coupling shaft.

6. The seat support device according to claim 5, wherein
the coupling arm bulges below a straight line connecting the coupling shaft and the second support shaft.

7. A bicycle comprising:
the seat support device which includes:
a seat post which includes a lower post supported so as to move forward and rearward centering on a first support shaft, and an upper post extending upward from the lower post, the upper post being configured to support a seat located at an upper side of the upper post and movable upward and downward relative to the lower post;
a seat position adjustment mechanism configured to switch between a locked state in which a relative position between the upper post and the lower post is locked, and an unlocked state in which a change in the relative position between the upper post and the lower post is allowed; and
a coupling arm coupled to the upper post, wherein
a foremost part of the coupling arm is supported by a second support shaft located in front of the seat post so that the coupling arm and the upper post are movable upward and downward centering on the second support shaft.

8. The bicycle according to claim 7, further comprising:
a frame, wherein
the frame includes a head tube configured to support a steering shaft, a frame bottom part configured to support a bottom bracket configured to support a crankshaft, and a mainframe part which extends rearward from the head tube to be coupled to the frame bottom part, and
the lower post is coupled to the mainframe part via the first support shaft.

9. The bicycle according to claim 8, wherein
the seat post is configured to move between a high post state in which the upper post is disposed at a relatively high position, and a low post state in which the upper post is disposed at a relatively low position, and
when the seat post is in the low post state, the seat post tilts rearward beyond the mainframe part.

10. The bicycle according to claim 7, further comprising:
a frame, wherein
the frame includes a head tube configured to support a steering shaft, and a mainframe part extending rearward from the head tube, and
the coupling arm is coupled to the mainframe part via the second support shaft.

11. The bicycle according to claim 7, further comprising:
a frame, wherein
the frame includes a head tube configured to support a steering shaft, and a mainframe part extending rearward from the head tube,
the mainframe part includes a right extension part and a left extension part separated in a left-right direction, and
the coupling arm is at least partially disposed between the right extension part and the left extension part.

12. The bicycle according to claim 7, further comprising:
a frame, wherein
the frame includes a head tube configured to support a steering shaft, and a mainframe part extending rearward from the head tube,
the mainframe part includes a right extension part and a left extension part separated in a left-right direction, and
the seat post is at least partially disposed between the right extension part and the left extension part.
